(19) United States
(12) Patent Application Publication
(10) Pub. No.: US 2023/0385415 A1
(43) Pub. Date: Nov. 30, 2023

(54) ARRANGEMENT AND METHOD OF THREAT DETECTION IN A COMPUTER OR COMPUTER NETWORK

(71) Applicant: WithSecure Corporation, Helsinki (FI)

(72) Inventors: Broderick AQUILINO, Helsinki (FI); Pavel TURBIN, Helsinki (FI)

(21) Appl. No.: 18/326,401

(22) Filed: May 31, 2023

(30) Foreign Application Priority Data
May 31, 2022 (GB) 2208041.0

(51) Int. Cl. G06F 21/56; G06F 21/53; G06F 21/55

(52) U.S. Cl. CPC G06F 21/566; G06F 21/53; G06F 21/552; G06F 2221/033

(57) ABSTRACT

An arrangement and a method of threat detection in a computer or computer network, which method includes providing an thread and/or process to be analyzed for malware to a sandbox environment monitoring attempts of the thread or the process to create remote threads in the sandbox environment, and adding newly created thread(s) to a list of monitored threads, monitoring threads on the list of the monitored threads, providing a result of the malware analysis of the thread or the process on the basis of the execution in the sandbox environment based on the monitored threads, identifying the thread or the process as malicious or suspicious on the basis of the provided result, and taking an action for protecting the computer from the thread or the process identified as malicious or suspicious.

### CROSS-REFERENCE TO RELATED APPLICATIONS

This application claims the priority under 35 USC 119(a) of GB patent application 2208041.0 filed on May 31, 2022, the entirety of which is incorporated herein by reference.

### BACKGROUND OF THE INVENTION

### Field of the Invention

The present invention relates to an arrangement and a method of threat detection in a computer or computer network.

### Description of the Related Art

Malware detection and scanning is a vital issue for the security of any kind of endpoints and networks. Malware detection and scanning is generally directed to identify and potentially also disinfect any kind of malware on computer and/or communication systems, such as e.g. viruses, Trojans, worms, or other kinds of security threats.

Antimalware file scanning can be a slow process and can also depend on how reliable results are desired. Application sandboxing is one of the methods utilized by anti-malware and security for analysing files and applications. Sandboxing can be implemented as separate feature or be part of HIPS (host intrusion prevention system) solution.

Sandboxing permits to run an application under a restricted context in which access to local host is restricted e.g. file system is virtualized and later committed to the actual files or the changes of sandboxed application is deeper inspected and recorded. For these reasons sandboxing reduces the risk of running an unknown, possibly malicious application as the analysed application is isolated from the host and its activity can be tracing safely. Sandboxing is powerful tool for example for preventing ransomware and data stealers.

The current known sandbox solutions are not able to analyse the applications, process or files always reliably because the sandbox environment does not correspond the real environment in every aspect.

Therefore, it would be desirable to achieve a reliable malware detection utilizing sandbox which is also efficient and fast for the user of the device.

### SUMMARY OF THE INVENTION

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

The solution of the invention is able to achieve a reliable and efficient malware detection utilizing sandbox which is able to take into account remote threads created by the malicious application analyzed in the sandbox environment.

According to a first aspect, the invention relates a method, e.g. a computer implemented method, of threat detection in a computer or computer network, wherein the method comprises providing a thread and/or process to be analyzed for malware to a sandbox environment monitoring attempts of the thread or the process to create remote threads in the sandbox environment, and adding newly created thread(s) to a list of monitored threads, monitoring threads on the list of the monitored threads, providing a result of the malware analysis of the thread or the process on the basis of the monitoring in the sandbox environment based on the monitored threads, identifying the thread or the process as malicious or suspicious on the basis of the provided result, and taking an action for protecting the computer from the thread or the process identified as malicious or suspicious and/or an application or file by which the malicious or suspicious thread or process was created.

In one embodiment of the invention the method further comprises detecting the monitored process creating a new thread in a second process and creating a pair of processes and threads for the new thread and the second process and adding this pair to the list of monitored threads.

In one embodiment of the invention the method further comprises monitoring process identifications and thread identifications, and/or following file input-output, registry input-output, thread creations and/or process creations made on behalf of the monitored threads and/or the created pairs.

In one embodiment of the invention, the monitoring starts from a thread or process and comprises following succeeding process and/or thread creations, e.g. in the form of a process and/or thread tree. In one embodiment of the invention the method comprises monitoring process and/or thread tree and injected threads.

In one embodiment of the invention, if a thread or process is identified which is not created by another application, e.g. a clean application, that process and/or thread is determined to belong a monitored application's process and/or thread. In one embodiment of the invention, if another application, e.g. a clean application, performs an activity not from the process identification and thread identification pair, that process and/or thread is determined to belong to the other application, e.g. clean application, and is ignored.

In one embodiment of the invention the threads are identified with a thread identification information, such as thread ID and/or processes are identified with a process identification information, such as process ID.

In one embodiment of the invention if the monitored application, e.g. a monitored pair, creates a new worker thread, the new worker thread is added to the list of monitored threads.

In one embodiment of the invention the sandbox environment is an environment which permits an application to run in an environment in which access to local host is restricted and/or the changes to the system are reversable.

In one embodiment of the invention a malware file or application is a file or an application which writes its executable payload, e.g. as byte code, into memory of another application, e.g. clean application, or into shared memory and schedules a thread to run under the other application.

According to a second aspect, the invention relates to an arrangement for threat detection in a computer or computer network, wherein the arrangement comprises at least one computer. The computer is configured to provide a thread and/or a process to be analyzed for malware to a sandbox environment, to monitor attempts of the thread or the process to create remote threads in the sandbox environment, and to add newly created thread(s) to a list of monitored threads, to monitor threads on the list of the monitored threads, to provide a result of the malware analysis of the thread or the process on the basis of the execution in the sandbox environment based on the monitored threads, to identify the thread or the process as malicious or suspicious on the basis of the provided result, and to take an action for protecting the computer from the thread or the process identified as malicious or suspicious and/or an application or file by which the malicious or suspicious thread or process was created.

In one embodiment of the invention the arrangement is configured to carry out a method according to any embodiment of the invention.

According to a third aspect, the invention relates to a computer program comprising instructions which, when executed by a computer, cause the computer to carry out a method according to the invention.

According to a fourth aspect, the invention relates to a computer-readable medium comprising the computer program according to the invention.

To make sandboxing effective it is important to accurately identify application specific files and processes. Inclusion non application processes into sandbox increase noise and volume of traced data. In case of possible revert of sandboxed application some irrelevant but useful files could be deleted. In the opposite, if relevant app processes are not included into sandbox, the value of the analysis is reduced and produced sandboxed result becomes inconsistent.

Malware commonly utilizes different techniques to hide self and stay under radar. One of approaches is to run its code under host of another application, e.g. some known clean application, for example, explorer.exe. Malware launcher writes its executable payload as byte code into memory of another application and schedules a thread to run under the application. The thread performs the lateral moves. If anti-malware software would follow the other application as part of sandboxed target, then it has high chance to include into scope irrelevant files like made by user.

With the solution of the invention, it's possible to implement threat detection, e.g. detecting malicious files, applications or processes, in a reliable and efficient way in a sandbox environment. The solution of the invention is also able to reliably and efficiently monitor remote threads created by the monitored process or applications in the sandbox environment and therefore recognize e.g. thread injection made by malware also when the application is analyzed or run in a sandbox environment. The prior art solutions are not able to trace remote threads as the prior art solutions only sandbox the parent application and not the threads or children that the parent application launches.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated.

Furthermore, it is to be understood that the use of “a” or “an”, i.e. a singular form, throughout this document does not exclude a plurality.

### BRIEF DESCRIPTION OF THE DRAWINGS

The embodiments of the invention are illustrated by way of example, and not by way of limitation, in the figures of the accompanying drawings.

FIG. 1 presents as a schematic diagram a computer system or computer network configuration, for which exemplifying embodiments of the present invention are applicable.

FIG. 2 presents schematically an example how a malware launcher is able to create remote threads.

FIG. 3 presents an example method according to one embodiment of the invention.

FIG. 4 presents as a schematic diagram an example of a structure of an arrangement according to exemplifying embodiments of the present invention.

### DETAILED DESCRIPTION

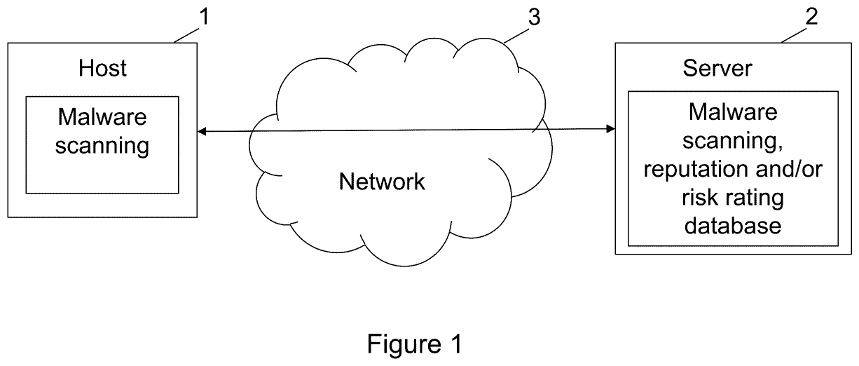

FIG. 1 presents an environment in which the solution of the invention can be used. In the solution of FIG. 1 a system configuration is presented in which a local host 1 and a remote entity or server 2 are connected via a network 3. Here, the host 1 exemplifies any computer or communication system, including a single device, a network node or a combination of devices, on which malware scanning is to be performed. The scanning can be done at the host and/or at the server. For example, the host 1 may include a personal computer, a personal communication device, a network-enabled device, a client, a firewall, a mail server, a proxy server, a database server, or the like. The server 2 exemplifies any computer or communication system, including a single device, a network node or a combination of devices, on which malware scanning can be performed for the host 1, or which can provide data for the host 1 required to carry out the malware scanning at the host, such as reputation data. For example, the server 2 may include a security entity or a backend entity of a security provider, or the like, and the server 2 may be realized in a cloud implementation or the like.

According to exemplifying embodiments of the invention, malware scanning at the host 1 and/or by the server 2 can be realized using a malware analysis environment, such as at the host or in a virtual machine or emulator environment, which can be arranged at the host and/or at the server. E.g a malware scanning agent, such as e.g. an anti-malware software can be installed/arranged at the host 1 to be used for malware scanning. The sandboxing of the malware application can be carried out at the malware analysis environment, e.g. at the host and/or at the server or at a virtual machine at the host and/or the server. The sandbox environment is an environment which permits an application to run in an environment in which access to local host is restricted and/or the changes to the system are reversable.

In one embodiment of the invention the malware scanning environment, service and/or software can detect starting and closing of applications, all unusual processes and attach monitoring to the required applications and processes. Also, when the services are started early, the service is able to detect and follow most of user's application. In one embodiment of the invention, when the malware scanning software or service is started up, it can perform running application inventory.

The network 3 exemplifies any computer or communication network, including e.g. a (wired or wireless) local area network like LAN, WLAN, Ethernet, or the like, a (wired or wireless) wide area network like WiMAX, GSM, UMTS, LTE, or the like, and so on. Hence, the host 1 and the server 2 can but do not need to be located at different locations. For example, the network 3 may be any kind of TCP/IP-based network. Insofar, communication between the host 1 and the server 2 over the network 3 can be realized using for example any standard or proprietary protocol carried over TCP/IP, and in such protocol the malware scanning agent at the host 1 and the malware analysis sandbox or application at the server 2 can be represented on/as the application layer.

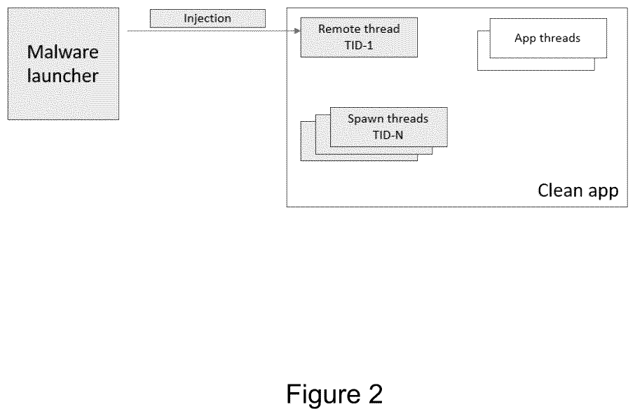

FIG. 2 presents one example scenario which can be handled by the at least some embodiments of the solution of the invention. The malware file or application which can be analyzed in a sandbox environment with the solution of the invention can be for example a malware file or an application which writes its executable payload, e.g. as byte code, into memory of another application, e.g. a clean application, or shared memory and schedules a thread to run under the other application.

The diagram of FIG. 2 illustrates a thread injection mechanism as an example. In this example, at first a malware launcher makes a thread TID-1 into clean and/or other application. The remote thread TID-1 runs in space of a clean and/or other application (which clean and/or other application is different application than the application which created the remote thread). The remote thread TID-1 can make worker threads TID-N as presented in the example. The clean and/or other application has a set of its own application specific threads. The remote thread TID-1 and its worker threads TID-N can then implement actual malware payload.

In the solution of the invention, when the thread and/or process is analyzed for malware in a sandbox environment, the analyzing process can start by monitoring attempts of the thread or the process to create remote threads. The newly created thread(s) are added to a list of monitored threads and the threads on the list of the monitored threads are monitored to be able to observe malicious activity. If the monitored thread or process is identified as malicious or suspicious on the basis of the monitoring, an action can be taken e.g. to protect the computer from an electronic file, the thread or the process identified as malicious or suspicious and/or an application or file by which the malicious or suspicious thread or process was created.

If for example a malware launcher is part of sandbox, the anti-malware application can follow its attempts to create remote threads. The newly created threads can be added to list of watched threads, and e.g. identified with thread ID.

In one embodiment of the invention, creation of remote threads can be detected by monitoring process creations of the monitored process and detecting the monitored process creating a new thread in a second process. This new thread can be added to the list of monitored threads. In one embodiment of the invention a pair of processes and threads is created for the new created thread and the second process, and this pair is added to the list of monitored threads. If the monitored application, e.g. a monitored pair, creates a new worker thread, the new worker thread can also be added to the list of monitored threads.

In one embodiment of the invention, the monitoring starts from a thread or process and comprises following succeeding process and/or thread creations, e.g. in the form of a process and/or thread tree. In one embodiment of the invention process and/or thread tree and injected threads are monitored.

In one embodiment of the invention, if another application, such as a clean application, performs an activity not from the process identification and thread identification pair, that process and/or thread can be determined to belong of to the other application and can be ignored. In one embodiment of the invention, if a thread or process is identified which is not created by another application, e.g. a clean file, such as an application, that process and/or thread is determined to belong a monitored application's process and/or thread, which monitored application is the application or file which is analyzed in the sandbox environment.

The threads and processes can be monitored by monitoring process identifications of the processes (e.g process IDs) and thread identifications of the threads (e.g. thread IDs) and/or following file input-output, registry (e.g. Windows registry) input-output, thread creations and/or process creations made on behalf of the monitored threads, processes and/or the created pairs.

The malware launcher application as presented in the FIG. 2 can be a user executable application for which a deeper threat analysis is required. In one embodiment a file, a document and/ or a script can be analyzed with the solution of the invention in addition or instead of the application.

In one embodiment of the invention, to prevent data stealing, processes of the application can be throttled e.g. the local file reading of sensitive documents and/or outbound network transmissions are slowed. If the analysis done in virtual machine or emulator finds that the application is not a threat, the above-mentioned actions, e.g. network throttling, can be ended and/or reverted to normal.

In one embodiment of the invention in which throttling is used, the throttling can allow the malware analyses to be completed and/or potential damage can be reduced if running application is found malicious. In one embodiment of the invention certain functionality, e.g. non network functionality, of analyzed app can be still kept running normally and it can reduce usability impacts of analysis. Thus, one possibility is to deny network functionality when throttling is used. In one embodiment of the invention known and trusted resources, such as IP-addresses, URLs, can be still allowed to operate at full speed during throttling.

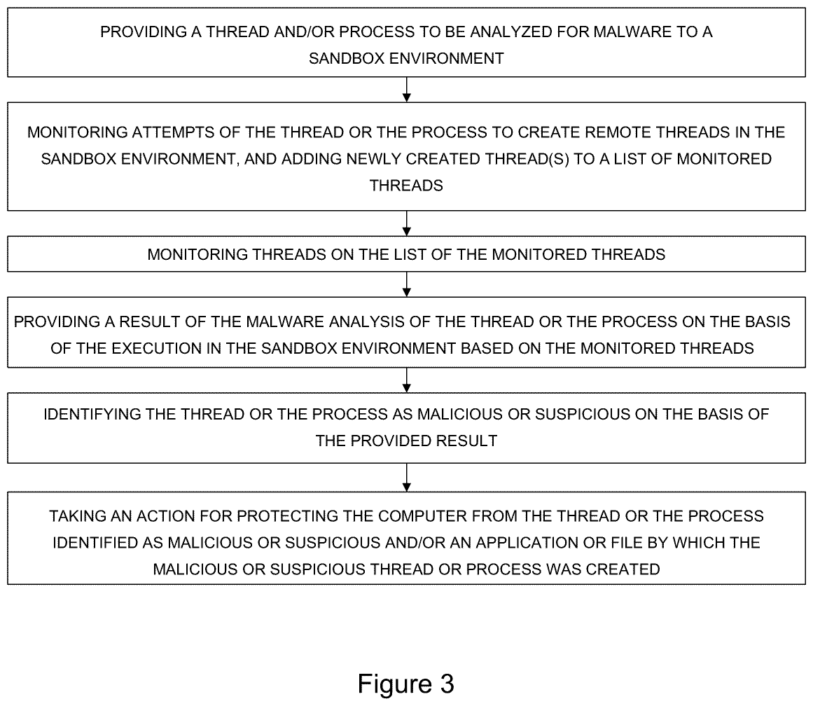

FIG. 3 presents an example method according to one embodiment of the invention. In the method a thread and/or process is provided to be analyzed for malware to a sandbox environment. The thread or the process is executed in the sandbox environment, attempts of the thread or the process to create remote threads are monitored. Newly created thread(s) are added to a list of monitored threads and threads on the list of the monitored threads are monitored. A result of the malware analysis of the thread or the process is provided on the basis of the execution in the sandbox environment based on the monitored threads. The thread or the process is identified as malicious or suspicious on the basis of the provided result. An action is taken for protecting the computer from an electronic file, the thread or the process identified as malicious or suspicious and/or an application or file by which the malicious or suspicious thread or process was created.

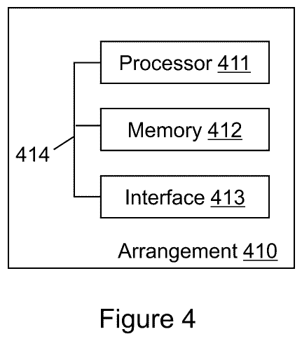

As presented in FIG. 4, an arrangement 410 or at least part of the arrangement, e.g. an endpoint and/or a server, according to exemplifying embodiments of the present invention may comprise at least one processor 411 and at least one memory 412 (and possibly also at least one interface 413), which may be operationally connected or coupled, for example by a bus 414 or the like, respectively.

The processor 411 of the arrangement 410 is configured to read and execute computer program code stored in the memory 412. The processor may be represented by a CPU (Central Processing Unit), a MPU (Micro Processor Unit), etc., or a combination thereof. The memory 412 of the arrangement 410 is configured to store computer program code, such as respective programs, computer/processor-executable instructions, macros or applets, etc. or parts of them. Such computer program code, when executed by the processor 411, enables the arrangement 410 to operate in accordance with exemplifying embodiments of the present invention. The memory 412 may be represented by a RAM (Random Access Memory), a ROM (Read Only Memory), a hard disk, a secondary storage device, etc., or a combination of two or more of these. The interface 413 of the arrangement 410 is configured to interface with another arrangement and/or the user of the arrangement 410. That is, the interface 413 may represent a communication interface (including e.g. a modem, an antenna, a transmitter, a receiver, a transceiver, or the like) and/or a user interface (such as a display, touch screen, keyboard, mouse, signal light, loudspeaker, or the like).

The arrangement 410 may, for example, represent a (part of a) first node, such as local entity or host 1 in FIG. 1, or may represent a (part of a) second node, such as remote entity or server 2 in FIG. 1. The arrangement 410 may be configured to perform a procedure and/or exhibit a functionality as described in any one of FIGS. 2 to 3.

According to exemplifying embodiments of the present invention, the electronic file to be analyzed for malware which creates processes and/or threads can be any electronic file, particularly encompassing any electronic file including a runnable/executable part, such as any kind of application file. Insofar, exemplifying embodiments of the present invention are applicable to any such electronic file, including for example a file of an Android Application Package (APK), a Portable Executable (PE), a Microsoft Soft Installer (MSI) or any other format capable of distributing and/or installing application software or middleware on a computer.

The data collected with the solution of the invention may be stored in a database or similar model for information storage for further use.

In an embodiment, the actions taken based on protecting the computer actions may be taken to secure the computer or the computer network when a malicious file, application or activity has been detected. Also, actions by changing the settings of the computers or other network nodes can be done. Changing the settings may include, for example, one or more nodes (which may be computers or other devices) being prevented from being switched off in order to preserve information in RAM, a firewall may be switched on at one or more nodes to cut off the attacker immediately, network connectivity of one or more of the network nodes may be slowed down or blocked, suspicious files may be removed or placed into quarantine, logs may be collected from network nodes, sets of command may be executed on network nodes, users of the one or more nodes may be warned that a threat or anomaly has been detected and that their workstation is under investigation, and/or a system update or software patch may be sent from the security backend to the nodes. In one embodiment of the invention one or more of these actions may be initiated automatically.

Although the invention has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein. Lists and groups of examples provided in the description given above are not exhaustive unless otherwise explicitly stated.

1. A method of threat detection in a computer or computer network, wherein the method comprises:
providing a thread and/or process to be analyzed for malware to a sandbox environment,
monitoring attempts of the thread or the process to create remote threads in the sandbox environment, and adding newly created thread(s) to a list of monitored threads,
monitoring threads on the list of the monitored threads,
providing a result of the malware analysis of the thread or the process on the basis of the execution in the sandbox environment based on the monitored threads,
identifying the thread or the process as malicious or suspicious on the basis of the provided result, and
taking an action for protecting the computer from the thread or the process identified as malicious or suspicious and/or an application or file by which the malicious or suspicious thread or process was created.

2. The method of claim 1, wherein the method further comprises detecting the monitored process creating a new thread in a second process and creating a pair of processes and threads for the new thread and the second process and adding this pair to the list of monitored threads.

3. The method of claim 2, wherein the method further comprises monitoring process identifications and thread identifications, and/or following file input-output, registry input-output, thread creations and/or process creations made on behalf of the monitored threads and/or the created pairs.

4. The method according to claim 1, wherein the monitoring starts from a thread or process and comprises following succeeding process and/or thread creations.

5. The method according to claim 1, wherein if another application performs an activity not from the process identification and thread identification pair, that process and/or thread is determined to belong to the other application and is ignored.

6. The method according to claim 1, wherein the threads are identified with a thread identification information and/or processes are identified with a process identification information.

7. The method according to claim 1, wherein if the monitored application creates a new worker thread, the new worker thread is added to the list of monitored threads.

8. The method according to claim 1, wherein the sandbox environment is an environment which permits an application to run in an environment in which access to local host is restricted and/or the changes to the system are reversable.

9. The method according to claim 1, wherein a malware file or application is a file or an application which writes an executable payload into memory of another application or shared memory and schedules a thread to run under the other application.

10. An arrangement for threat detection in a computer or computer network, wherein the arrangement comprises at least one computer, wherein the computer is configured:
to provide a thread and/or process to be analyzed for malware to a sandbox environment,
to monitor attempts of the thread or the process to create remote threads in the sandbox environment, and to add newly created thread(s) to a list of monitored threads,
to monitor threads on the list of the monitored threads,
to provide a result of the malware analysis of the thread or the process on the basis of the execution in the sandbox environment based on the monitored threads,
to identify the thread or the process as malicious or suspicious on the basis of the provided result, and
to take an action for protecting the computer from the thread or the process identified as malicious or suspicious and/or an application or file by which the malicious or suspicious thread or process was created.

11. An arrangement for threat detection in a computer or computer network, wherein the arrangement comprises at least one computer, wherein the computer is configured:
to provide a thread and/or process to be analyzed for malware to a sandbox environment,
to monitor attempts of the thread or the process to create remote threads in the sandbox environment, and to add newly created thread(s) to a list of monitored threads,
to monitor threads on the list of the monitored threads,
to provide a result of the malware analysis of the thread or the process on the basis of the execution in the sandbox environment based on the monitored threads,
to identify the thread or the process as malicious or suspicious on the basis of the provided result, and
to take an action for protecting the computer from the thread or the process identified as malicious or suspicious and/or an application or file by which the malicious or suspicious thread or process was created, wherein the arrangement is configured to carry out a method according to claim 2.

12. (canceled)

13. A computer-readable medium on which is stored a computer program that, when executed by a computer, causes the computer to carry out the method of claim 1.

14. The method according to claim 2, wherein the monitoring starts from a thread or process and comprises following succeeding process and/or thread creations.

15. The method according to claim 3, wherein the monitoring starts from a thread or process and comprises following succeeding process and/or thread creations.

16. The method according to claim 2, wherein if another application performs an activity not from the process identification and thread identification pair, that process and/or thread is determined to belong to the other application and is ignored.

17. The method according to claim 3, wherein if another application performs an activity not from the process identification and thread identification pair, that process and/or thread is determined to belong to the other application and is ignored.

18. The method according to claim 4, wherein if another application performs an activity not from the process identification and thread identification pair, that process and/or thread is determined to belong to the other application and is ignored.

19. The method according to claim 2, wherein the threads are identified with a thread identification information and/or processes are identified with a process identification information.

20. The method according to claim 3, wherein the threads are identified with a thread identification information and/or processes are identified with a process identification information.
